(19) United States
(12) Patent Application Publication
(10) Pub. No.: US 2005/0168408 A1
(43) Pub. Date: Aug. 4, 2005

(54) Plasma display panel and driving method thereof

(76) Inventors: Kazuhiro Ito, Suwon-si (KR); Nam-Sung Jung, Suwon-si (KR)

Correspondence Address: CHRISTIE, PARKER & HALE, LLP, PO BOX 7068, PASADENA, CA, 91109-7068, US

(21) Appl. No.: 11/046,475

(22) Filed: Jan. 28, 2005

(30) Foreign Application Priority Data
Jan. 30, 2004 (KR) 10-2004-0005972

(51) Int. Cl. G09G 3/28

(52) U.S. Cl. 345/60

(57) ABSTRACT

A plasma display panel (PDP) and a method for driving the PDP, in which address data is applied to address electrodes grouped into two groups in an address period in such a manner that the address data application is carried out for respective address electrode groups at different times. Accordingly, discharge current generated due to address discharge may be distributed in terms of time, and a voltage drop occurring in the address period may be reduced.

### CROSS REFERENCE TO RELATED APPLICATION

This application claims priority to and the benefit of Korean Patent Application No. 10-2004-0005972 filed on Jan. 30, 2004, in the Korean Intellectual Property Office, the contents of which are incorporated herein by reference.

### BACKGROUND OF THE INVENTION

(a) Field of the Invention

The present invention relates to a plasma display panel (PDP) and a driving method thereof.

(b) Description of the Related Art

Recently, flat panel displays, such as liquid crystal displays (LCDs), field emission displays (FEDs) and PDPs, have been actively developed. The PDPs are advantageous over the other flat panel displays in regard to their high luminance, high luminous efficiency and wide viewing angle. Accordingly, the PDPs are being highlighted as a substitute for conventional cathode ray tubes (CRTs) for large-screen displays of more than 40 inches.

The PDPs are flat panel displays that use plasma generated by gas discharge to display characters or images. The PDPs include, according to their size, more than several tens to millions of pixels arranged in the form of a matrix. These PDPs are classified into a direct current (DC) type and an alternating current (AC) type according to patterns of waveforms of driving voltages applied thereto and discharge cell structures thereof.

The DC PDP has electrodes exposed to a discharge space, thereby causing current to directly flow through the discharge space during application of a voltage to the DC PDP. In this connection, the DC PDP has a disadvantage in that it requires a resistor for limiting the current. On the other hand, the AC PDP has electrodes covered with a dielectric layer that naturally forms a capacitance component to limit the current and protects the electrodes from the impact of ions during a discharge. As a result, the AC PDP is superior over the DC PDP with regard to a long lifetime.

Such an AC PDP includes scan electrodes and sustain electrodes which are formed on one main surface of the PDP and are arranged in parallel. Address electrodes are formed on the other main surface of the PDP and extend in a direction orthogonal to the scan electrodes and sustain electrodes. The sustain electrodes correspond to respective scan electrodes and are coupled in common.

FIG. 1 is a perspective view illustrating a part of an AC PDP. Scan electrodes 4 and sustain electrodes 5 covered with a dielectric layer 2 and a protective layer 3 are arranged in pairs in parallel on a first glass substrate 1. A plurality of address electrodes 8 covered with an insulation layer 7 are arranged on a second glass substrate 6. Barrier ribs 9 are formed in parallel with the address electrodes 8 on the insulation layer 7 such that each barrier rib 9 is interposed between the adjacent address electrodes 8. A phosphor 10 is coated on the surface of the insulation layer 7 and on both sides of each barrier rib 9. The first and second glass substrates 1, 6 are arranged to face each other while defining a discharge space 11 therebetween so that the address electrodes 8 are orthogonal to the scan electrodes 4 and sustain electrodes 5. In the discharge space, a discharge cell 12 is formed at an intersection between each address electrode 8 and each pair of the scan electrodes 4 and sustain electrodes

FIG. 2 shows an arrangement of the electrodes in the PDP of FIG. 1. The electrodes of the PDP are arranged in the form of an m×n matrix. In more detail, m address electrodes A1 to Am are arranged in a column direction. Also, n scan electrodes Y1 to Yn and n sustain electrodes X1 to Xn are alternately arranged in a row direction. Hereinafter, the scan electrodes are referred to as “Y-electrodes”, and the sustain electrodes are referred to as “X-electrodes”.

There are various methods to display a frame by discharging cells of a PDP. One typical method is the sub-field method and another typical method is the line erase scanning method. In the sub-field method, one frame to be displayed in accordance with a cell discharge is divided into a plurality of sub-frames. The sub-frames are overlapped under the control of drivers for sustain electrodes and address electrodes to realize display of one frame.

FIG. 3 illustrates driving waveforms according to an example of a conventional sub-field method. In the conventional sub-field method, an address operation (programming operation) is carried out for every sub-field whereby the electrodes are driven in a state of being divided into a plurality of groups. In this case, the address drivers driving respective electrode groups have the same timing for the output of address pulse data.

Where the PDP is driven in accordance with the above-mentioned driving method, however, an increase in the amount of discharge current occurs when the number of cells performing a discharge operation in one scan line increases, for example, to display image data of a white-screen. As a result, a voltage drop occurs. Furthermore, when such a voltage drop is high, a drive margin is restricted. In the latter case, insufficient discharge may occur.

### SUMMARY OF THE INVENTION

In accordance with the present invention a PDP and a driving method thereof, in which discharge current generated in accordance with an address discharge operation is distributed to prevent a voltage drop, is provided.

In accordance with one aspect, embodiments of the present invention provide a plasma display panel including a panel, a controller, a first address driver, a second address driver, and a scan driver. The panel includes a plurality of address electrodes, a plurality of scan electrodes, and a plurality of sustain electrodes arranged in pairs together with the scan electrodes. The controller corrects an externally-input image signal and outputs the resultant data. The first address driver generates first address data based on the data output from the controller, and applies the first address data to a first group of the address electrodes. The second address driver generates second address data based on the data output from the controller, and applies the second address data to a second group of the address electrodes. The scan driver generates scan pulse data based on the data output from the controller, and applies the scan pulse data to the scan electrodes, wherein the controller outputs control signals to control the first and second drivers to output the first address data and the second address data at different times, respectively.

The controller may perform control operations such that the first address data from the first address driver is output simultaneously with the output of the scan pulse data from the scan driver, and the second address data from the second address driver is output after a predetermined time elapses from the output of the first address data.

The controller may perform a control operation such that the output of the first and second address data is ended simultaneously with a time when the output of the scan pulse data from the scan driver is ended.

The control unit may perform a control operation such that the scan pulse data from the scan driver and the second address data from the second address driver are simultaneously output after an n-th sub-field period (n being a natural number), and the address data from the first address driver is then output after a predetermined time elapses from the output of the first address data.

In accordance with another aspect, the present invention provides a method for driving a plasma display panel including a plurality of scan electrodes, a first address electrode group having a plurality of first address electrodes, and a second address electrode group having a plurality of second address electrodes. In the method, a) address pulses are applied to the first address electrodes of the first address electrode group, respectively, in an address period; and b) address pulses are applied to the second address electrodes of the second address electrode group, respectively, in the address period after a predetermined time elapses from the address pulse application to the first address electrodes.

In the method, c) the address pulse application to the first address electrodes and the address pulse application to the second address electrodes are simultaneously ended.

### BRIEF DESCRIPTION OF THE DRAWINGS

FIG. 1 is a perspective view illustrating a part of a general AC PDP.

FIG. 2 is a schematic view illustrating an arrangement of electrodes in the PDP of FIG. 1.

FIG. 3 is a waveform diagram illustrating driving waveforms according to an example of a conventional sub-field method.

FIG. 4 is a block diagram of the PDP according to an exemplary embodiment of the present invention.

FIG. 5 is a waveform diagram depicting waveforms of signals generated in the PDP according to an exemplary embodiment of the present invention.

FIG. 6 is a waveform diagram depicting waveforms of signals generated in the PDP in an address period of the n-th frame according to an exemplary embodiment of the present invention.

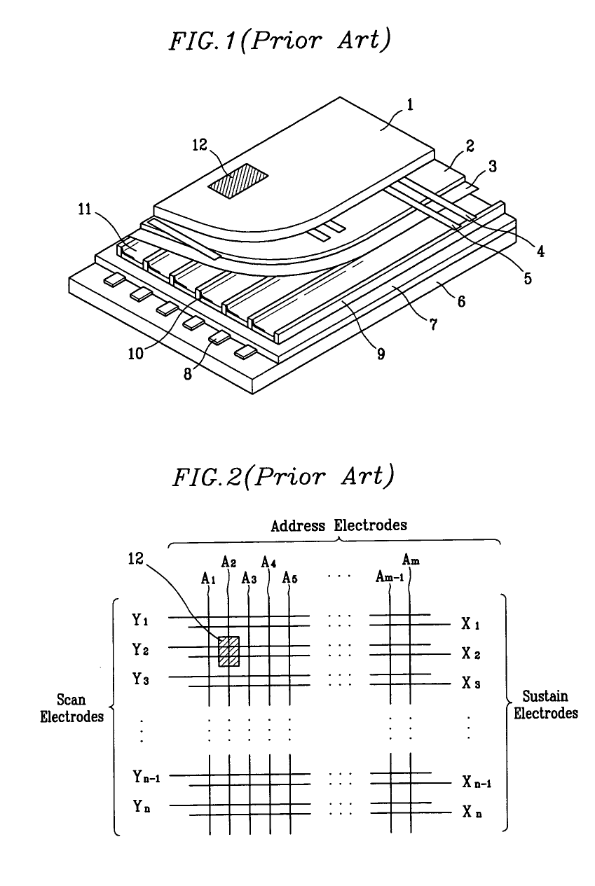

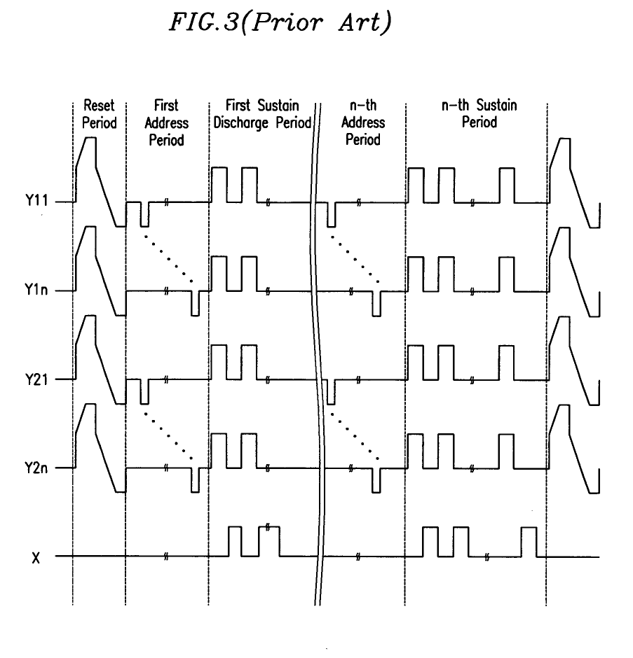

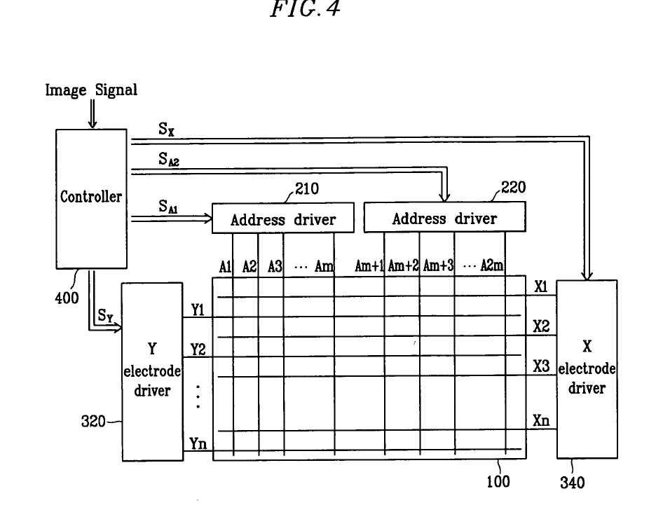

### DETAILED DESCRIPTION

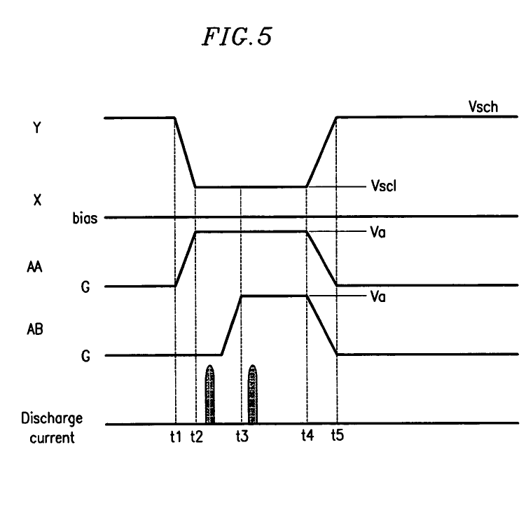

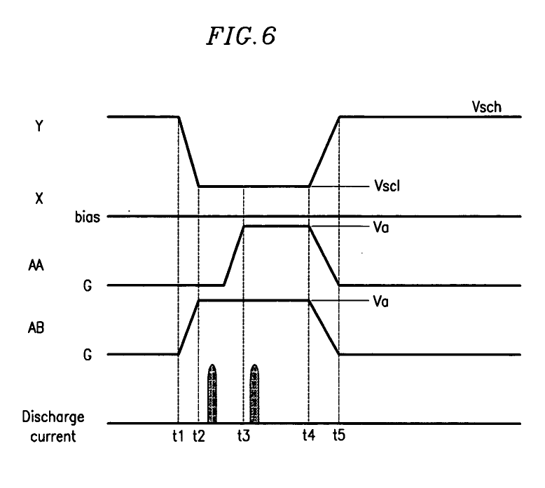

A PDP driving device according to an exemplary embodiment of the present invention will now be described in detail with reference to FIGS. 4 and 5. The PDP includes a plasma panel 100, address drivers 210, 220, a Y-electrode driver 320, an X-electrode driver 340, and a controller 400.

The plasma panel 100 includes a plurality of address electrodes A1 to A2m arranged in the column direction, and a plurality of first electrodes (hereinafter, referred to as “Y-electrodes”) Y1 to Yn arranged in a row direction, and a plurality of second electrodes (hereinafter, referred to as “X-electrodes”) X1 to Xn arranged in the row direction.

The address driver 210 receives an address driving control signal S_{A1} from the controller 400, and applies display data signals to a first group of address electrodes, that is, the address electrodes A1 to Am, for selecting desired discharge cells, respectively. The address driver 220 receives an address driving control signal S_{A2} from the controller 400, and applies display data signals to a second group of address electrodes, that is, the address electrodes Am+1 to A2m, for selecting desired discharge cells, respectively.

The Y-electrode driver 320 receives a Y-electrode drive signal S_{Y} from the controller 400, and applies drive signals to the Y-electrodes Y1 to Yn, respectively. The X-electrode driver 340 receives an X-electrode drive signal S_{X} from the controller 400, and applies a drive signal to the X-electrodes X1 to Xn.

The controller 400 externally receives an image signal, and generates address driving control signals S_{A1}, and S_{A2}, Y-electrode drive signal S_{Y}, and X-electrode drive signal S_{X}, and applies the generated signals to the address drivers 210, 220, Y-electrode driver 320, and X-electrode driver 340, respectively.

The controller 400 also outputs timing signals to drive the address drivers 210, 220, respectively, together with the address driving control signals S_{A1}, S_{A2}. In sync with the timing signals, the address drivers 210, 220 output address data signals, respectively.

FIG. 5 is a waveform diagram depicting waveforms of signals generated in the PDP according to the illustrated embodiment of the present invention. The address drivers 210, 220 output data at different timings, respectively. That is, the address driver 210 first outputs address data AA when a scan signal is applied to a Y-electrode (t1). After a predetermined time elapses (t3), the address driver 220 outputs address data AB.

In this case, the address data AA and the address data AB have the same drive voltage level Va. Although the address data AA and address data AB are applied at different times, respectively, their voltage levels fall at the same time, that is, at a time t4 when the scan signal applied to the Y-electrode rises.

When the times when the address data AA and address data AB are applied, respectively, are different from each other, as described above, it is possible to distribute discharge current generated due to address discharge, in terms of time, and to reduce a voltage drop occurring in the address period.

Although the address drivers 210, 220 are driven for every frame in such a manner that the address driver 210 is first driven, and the address driver 220 is then driven, in accordance with the illustrated embodiment of the present invention, the driving order of the address drivers 210, 220 may be alternately changed for successive frames.

FIG. 6 is a waveform diagram depicting waveforms of signals generated in the PDP in an address period of the n-th frame according to an exemplary embodiment of the present invention. As shown, the address driver 220 is driven to apply address data to the address electrode AB, and the address driver 210 is driven to apply address data to the address electrode AA, in the n-th frame when a predetermined time is passed.

Also, although the illustrated embodiment of the present invention has been described in conjunction with the case in which two address drivers are used, three or more address drivers may be used to drive the address electrodes.

In addition, although address data is output in such a manner that it is distributed using two or more address drivers, it may be output in a distributed manner, using a single address driver which includes addressing integrated circuits, each including an address select circuit.

As apparent from the above description, in accordance with the present invention, address data is output in a distributed manner in an address period so that it is possible to prevent surge of discharge current at a time when the address data is output. Accordingly, it is possible to reduce a voltage drop, and thus, to widen a drive margin and to prevent insufficient discharge.

While this invention has been described in connection with certain exemplary embodiments, it is to be understood that the invention is not limited to the disclosed embodiments, but, on the contrary, is intended to cover various modifications and equivalent arrangements included within the spirit and scope of the appended claims.

1. A plasma display panel comprising:
a panel including a plurality of address electrodes, and including a plurality of scan electrodes and sustain electrodes arranged in respective pairs;
a controller adapted to receive input image signals and to output resultant data;
a first address driver adapted to generate first address data based on the resultant data and to apply the first address data to a first group of the address electrodes;
a second address driver to generate second address data based on the resultant data and to apply the second address data to a second group of the address electrodes; and
a scan driver to generate scan pulse data based on the resultant data output and to apply the scan pulse data to the scan electrodes,
wherein the controller outputs control signals to control the first address driver and the second address driver to output the first address data and the second address data at different times, respectively.

2. The plasma display panel of claim 1, wherein the controller performs control operations such that the first address data from the first address driver is output simultaneously with an output of the scan pulse data from the scan driver, and the second address data from the second address driver is output after a predetermined time elapses from the output of the first address data.

3. The plasma display panel of claim 1, wherein the controller performs a control operation such that the output of the first address data and the second address data is ended simultaneously with a time when the output of the scan pulse data from the scan driver is ended.

4. The plasma display panel of claim 2, wherein the controller performs a control operation such that the output of the first address data and the second address data end simultaneously when the output of the scan pulse data from the scan driver ends.

5. The plasma display panel of claim 1, wherein the controller performs a control operation such that the scan pulse data from the scan driver and the second address data from the second address driver are simultaneously output after an n-th sub-field period, n being a natural number, and the address data from the first address driver is then output after a predetermined time elapses from the output of the second address data.

6. The plasma display panel of claim 2, wherein the controller performs a control operation such that the scan pulse data from the scan driver and the second address data from the second address driver are simultaneously output after an n-th sub-field period, n being a natural number, and the address data from the first address driver is then output after a predetermined time elapses from the output of the second address data.

7. A method for driving a plasma display panel including a plurality of scan electrodes, a first address electrode group having a plurality of first address electrodes, and a second address electrode group having a plurality of second address electrodes, comprising:
a) applying address pulses to the first address electrodes of the first address electrode group, respectively, in an address period; and
b) applying address pulses to the second address electrodes of the second address electrode group, respectively, in the address period after a predetermined time elapses from the address pulse application to the first address electrodes.

8. The method of claim 7, further comprising:
c) simultaneously ending address pulse application to the first address electrodes and address pulse application to the second address electrodes.

9. A method of addressing a plasma display panel having address electrodes and scan electrodes, comprising:
grouping the address electrodes into a first group and a second group;
driving first address data to the first group upon driving the scan electrodes;
driving second address data to the second group after a predetemined time elapses from the driving first address data; and
terminating both the driving first address data and the driving second address data upon terminating driving the scan electrodes.

10. The method of claim 9, wherein the first address data and the second address data are driven at the same drive voltage level.
